(19) United States
(12) Patent Application Publication
(10) Pub. No.: US 2015/0163244 A1
(43) Pub. Date: Jun. 11, 2015

(54) APPARATUS AND SYSTEM FOR PACKET TRANSMISSION

(71) Applicant: FUJITSU LIMITED, KAWASAKI-SHI (JP)

(72) Inventor: KIYOHISA HOSHINO, Yokohama (JP)

(21) Appl. No.: 14/558,753

(22) Filed: Dec. 3, 2014

(30) Foreign Application Priority Data
Dec. 11, 2013 (JP) 2013-256289

(51) Int. Cl. H04L 29/06

(52) U.S. Cl. CPC H04L 63/164; H04L 63/1458

(57) ABSTRACT

A packet transmission apparatus verifies a sequence number of each received packet using an anti-replay window. Upon detecting a suspected packet with a sequence number exceeding a highest sequence number set in the anti-replay window, an inquiry transmitting unit transmits a highest sequence number inquiry to an opposing apparatus. An anti-replay control unit drops the suspected packet when the sequence number of the suspected packet is more than a highest sequence number acquired from a response of the opposing apparatus in reply to the highest sequence number inquiry.

### CROSS-REFERENCE TO RELATED APPLICATION

This application is based upon and claims the benefit of priority of the prior Japanese Patent Application No. 2013-256289, filed on Dec. 11, 2013, the entire contents of which are incorporated herein by reference.

### FIELD

The embodiments discussed herein are related to an apparatus and system for packet transmission

### BACKGROUND

In recent network environments, crimes exploiting security vulnerabilities, such as data leakage and service interruptions due to hacking, have shown a tendency to increase more than ever. For example, radio base station apparatuses of mobile communication systems, such as the Long Term Evolution (LTE), support an important social infrastructure and are, therefore, expected to provide high reliability. Security vulnerabilities in the radio base station apparatuses have a substantial impact on social economy and are, therefore, a matter of great concern to us. Hence, a highly robust protocol for sniffing prevention and alteration detection is needed, and Internet Protocol Security Protocol (hereinafter referred to as “IPsec”) has been widely used as a security protocol in the Internet Protocol (IP) layer.

One of the security features offered by IPsec is anti-replay protection. The anti-replay protection detects a bogus packet sent from an attacker and discards the detected packet. For example, upon receiving an IPsec packet, a radio base station apparatus updates a bitmap of its anti-replay window. In addition, if the received IPsec packet is a packet for updating the highest sequence number, the radio base station apparatus shifts the anti-replay window. The radio base station apparatus determines the duplication of a sequence number according to the bitmap of the anti-replay, and drops an IPsec packet with a sequence number having previously been received. In addition, the radio base station apparatus also drops an IPsec packet with an old sequence number falling outside the anti-replay window.

RFC4301, “Security Architecture for the Internet Protocol”, December 2005

RFC4303, “IP Encapsulating Security Payload (ESP)”, December 2005

RFC4306, “Internet Key Exchange (IKEv2) Protocol”, December 2005

However, in the case where an attacker transmits an IPsec packet with a forged highest sequence number, the anti-replay window shifts according to the highest sequence number. Then, subsequent valid IPsec packets may be dropped, being regarded as IPsec packets with old sequence numbers outside the window of acceptable sequence numbers. Such an attack forging the highest sequence number causes communication failures, seriously affecting the continuation of services of a packet transmission apparatus, such as a radio base station apparatus, and a packet transmission system.

### SUMMARY

According to one embodiment, there is provided a packet transmission apparatus including an inquiry transmitting unit configured to transmit, upon detecting a suspected packet with a sequence number exceeding a highest sequence number set in an anti-replay window used to detect the duplication of a sequence number of a received packet, a highest sequence number inquiry to an opposing apparatus; and an anti-replay control unit configured to drop the suspected packet when the sequence number of the suspected packet is more than a highest sequence number acquired from a response of the opposing apparatus in reply to the highest sequence number inquiry.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a configuration of a packet transmission apparatus according to a first embodiment;

FIG. 2 illustrates an example of a configuration of a radio access system according to a second embodiment;

FIG. 3 illustrates an example of a functional configuration of a radio base station apparatus according to the second embodiment;

FIG. 4 illustrates an example of a functional configuration of a security gateway according to the second embodiment;

FIG. 5 illustrates an example of a hardware configuration of the radio base station apparatus according to the second embodiment;

FIG. 6 illustrates an example of a hardware configuration of the security gateway according to the second embodiment;

FIG. 7 is a flowchart of a packet reception process according to the second embodiment;

FIG. 8 illustrates an example of an anti-replay window according to the second embodiment;

FIG. 9 is a flowchart of a highest sequence number (HSN) check process according to the second embodiment;

FIG. 10 is a flowchart of an inquiry response reception process according to the second embodiment;

FIG. 11 is a flowchart of a receivable HSN setting process according to the second embodiment;

FIG. 12 illustrates an example of a receivable HSN threshold table according to the second embodiment;

FIG. 13 is a sequence diagram illustrating an example of an attack forging a highest sequence number; and

FIG. 14 is a sequence diagram illustrating an example of defense against the attack forging the highest sequence number.

### DESCRIPTION OF EMBODIMENTS

Several embodiments will be described below with reference to the accompanying drawings, wherein like reference numerals refer to like elements throughout.

### (a) First Embodiment

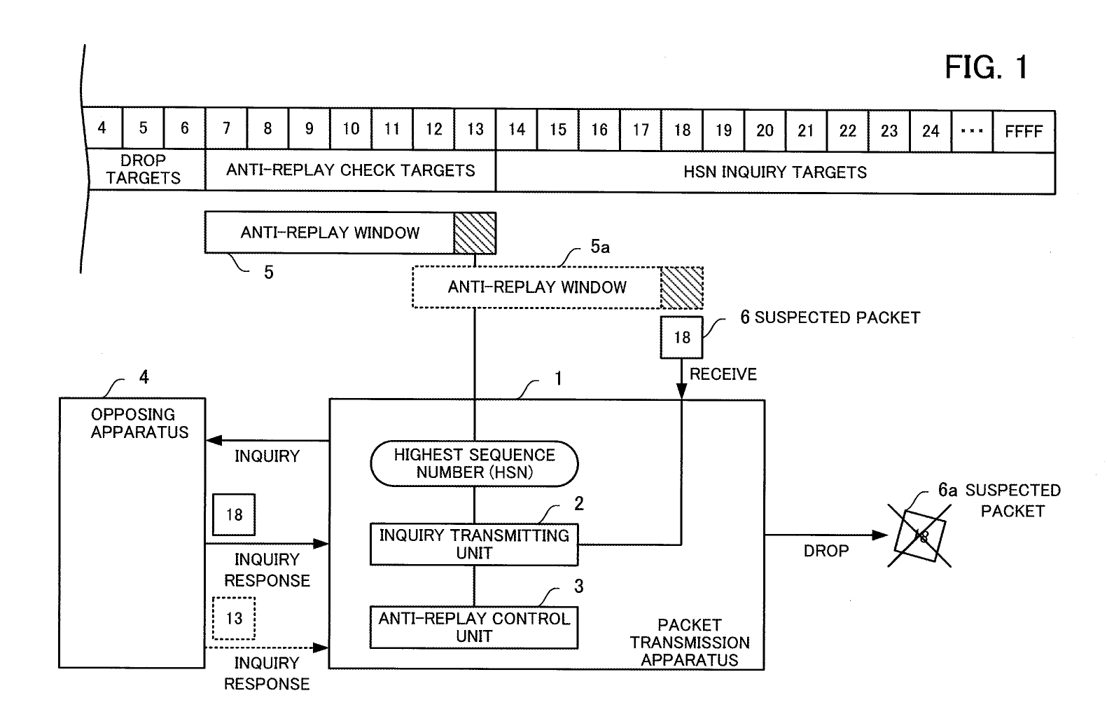

First, a packet transmission apparatus of a first embodiment is described with reference to FIG. 1. FIG. 1 illustrates an example of a configuration of the packet transmission apparatus according to the first embodiment. A packet transmission apparatus 1 (a first packet transmission apparatus) is a communication apparatus for transmitting and receiving packets to and from an opposing apparatus 4 (a second packet transmission apparatus). The packet transmission apparatus 1 and the opposing apparatus 4 are composing elements of a packet transmission system.

Each packet to be received or transmitted by the packet transmission apparatus 1 is assigned a sequence number. The packet transmission apparatus 1 verifies a received packet based on its assigned sequence number. The packet transmission apparatus 1 verifies the sequence number using an anti-replay window 5. The anti-replay window 5 has a bitmap of a predetermined window size, and the right edge of the anti-replay window 5 represents the highest sequence number so far received by the packet transmission apparatus 1 for a valid (i.e., not dropped) packet. The bitmap indicates whether a packet with a sequence number associated with each bit has already been received.

For example, as for the anti-replay window 5, the highest sequence number is “13” and the window size is seven packets. The packet transmission apparatus 1 recognizes sequence numbers in the anti-replay window 5 as anti-replay check targets. That is, the packet transmission apparatus 1 detects the duplication of the sequence number of a received packet using the anti-replay window 5. In addition, the packet transmission apparatus 1 regards packets with old sequence numbers outside the anti-replay window 5 as drop (discard) targets.

The packet transmission apparatus 1 includes an inquiry transmitting unit 2 and an anti-replay control unit 3. The inquiry transmitting unit 2 is configured to transmit, upon detecting a suspected packet 6 with a sequence number exceeding the highest sequence number set in the anti-replay window 5, a highest sequence number inquiry to the opposing apparatus 4. For example, when the highest sequence number is updated by the reception of the suspected packet 6 with a sequence number of 18, the anti-replay window 5 shifts to become an anti-replay window 5a. Herewith, packets with old sequence numbers of 11 and less outside the anti-replay window 5a become drop targets. In view of this, the inquiry transmitting unit 2 determines whether the suspected packet 6 has been transmitted by the opposing apparatus 4, by transmitting an inquiry about the highest sequence number to the opposing apparatus 4. Note that the inquiry transmitting unit 2 may transmit such an inquiry each time when updating the highest sequence number. Alternatively, the inquiry transmitting unit 2 may transmit such an inquiry about the highest sequence number when the shift amount of the anti-replay window 5 (an increase in the highest sequence number) is to be more than a predetermined threshold.

The anti-replay control unit 3 drops the suspected packet 6 when the sequence number of the suspected packet 6 is more than the highest sequence number acquired from a response of the opposing apparatus 4 in reply to the inquiry. For example, when the inquiry response of the opposing apparatus 4 indicates the highest sequence number being “13”, the sequence number “18” of the suspected packet 6 is more than the highest sequence number “13”. As a result, the anti-replay control unit 3 drops the suspected packet 6 as a suspected packet 6a. On the other hand, if the inquiry response of the opposing apparatus 4 indicates the highest sequence number being “18”, the anti-replay control unit 3 accepts the suspect packet 6 as a valid packet because the sequence number “18” of the suspected packet 6 is not more than the highest sequence number “18”, and then updates the highest sequence number. In addition, the anti-replay control unit 3 shifts the anti-replay window 5 to update it to the anti-replay window 5a.

Thus, the packet transmission apparatus 1 makes an inquiry to the opposing apparatus 4 about the suspected packet 6 for updating the highest sequence number, to thereby detect an attack forging the highest sequence number to counteract such threats. Herewith, the packet transmission apparatus 1 is able to prevent the occurrence of communication failures due to the attack forging the highest sequence number and avoid adverse effects on the continuation of services of the packet transmission apparatus 1 (an example of which is a radio base station apparatus) and tne packet transmission system. Therefore, the packet transmission apparatus 1 is able to provide a reliable communication network while preventing service interruptions.

### (b) Second Embodiment

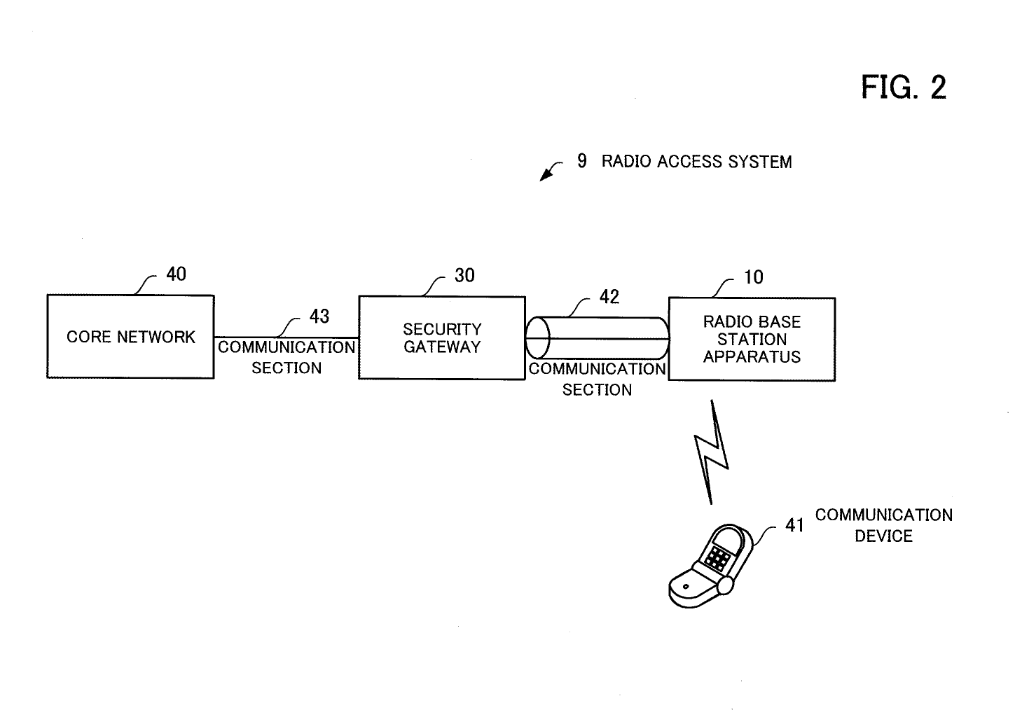

Next described is a packet transmission apparatus according to a second embodiment. First, a radio access system is described with reference to FIG. 2. FIG. 2 illustrates an example of a configuration of the radio access system according to the second embodiment. A radio access system 9 includes a radio base station apparatus 10, a security gateway 30, and a communication section 42 connecting the radio station apparatus 10 and the security gateway 30. The radio base station apparatus 10 is an application of a packet transmission apparatus, and the radio access system 9 is an application of a packet transmission system.

The radio base station apparatus 10 provides radio base station functions of wirelessly communicating with a communication device 41, such as a mobile phone or smart phone. For example, the radio access system 9 including the radio base station apparatus 10 implements a mobile communication system such as LTE. The radio base station apparatus 10 exchanges keys with the security gateway 30 using Internet Key Exchange (IKE), and establishes the communication section 42 by IPsec to thereby connect with the security gateway 30. Therefore, the radio base station apparatus 10 connects with the security gateway 30 on a peer-to-peer basis. The security gateway 30 is an opposing apparatus of the radio base station apparatus 10. The security gateway 30 connects with a core network 40 via a communication section 43. The communication section 43 here is an unencrypted communication section, however, may be an encrypted communication section as in the case of the communication section 42.

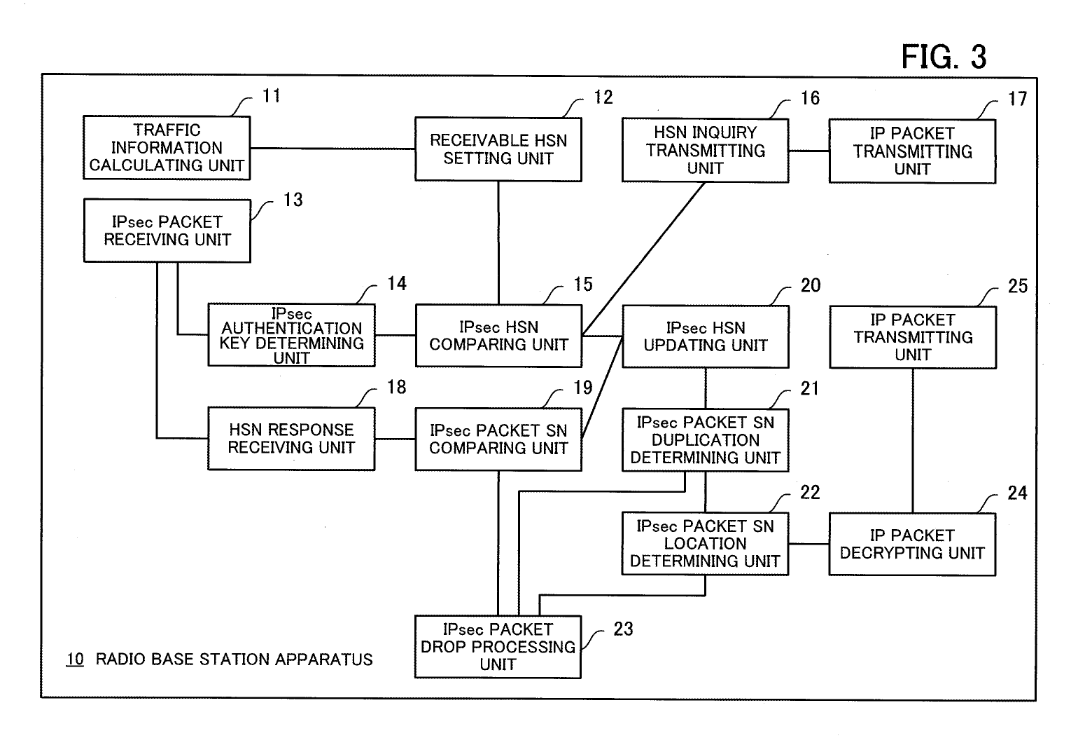

Functions of the radio base station apparatus 10 are described next with reference to FIG. 3. FIG. 3 illustrates an example of a functional configuration of the radio base station apparatus according to the second embodiment. The radio base station apparatus 10 includes a traffic information calculating unit 11, a receivable highest sequence number (HSN) setting unit 12, an IPsec packet receiving unit 13, an IPsec authentication key determining unit 14, and IPsec HSN comparing unit 15. The radio base station apparatus 10 also includes a HSN inquiry transmitting unit 16, an IP packet transmitting unit (up-link) 17, a HSN response receiving unit 18, and an IPsec packet sequence number (SN) comparing unit 19. Further, the radio base station apparatus 10 includes an IPsec HSN updating unit 20, an IPsec packet SN duplication determining unit 21, an IPsec packet SN location determining unit 22, and an IPsec packet drop processing unit 23. The radio base station apparatus 10 further includes an IP packet decrypting unit 24 and an IP packet transmitting unit (down-link) 25.

The traffic information calculating unit 11 calculates traffic information of a line used. The used line means a line connecting the radio base station apparatus 10 and the opposing apparatus (i.e., the security gateway 30) of the radio base station apparatus 10. That is, the communication section 42 is the used line whose traffic information is to be calculated. The traffic information is information on the traffic of the used line and, bandwidth usage is an example of such traffic information. The traffic information calculating unit 11 calculates the traffic information from the amount of data received through the used line. Note that the traffic information calculating unit 11 may be referred to as an acquiring unit configured to acquire the traffic information of the used line.

The receivable HSN setting unit 12 (a setting unit) sets a receivable highest sequence number. The receivable highest sequence number is, among sequence numbers exceeding the highest sequence number of an anti-replay window, the highest sequence number receivable without the need for an inquiry to the opposing apparatus. The receivable HSN setting unit 12 sets, as a threshold, an increment with respect to the highest sequence number of the anti-replay window. The threshold is variable, and the receivable HSN setting unit 12 sets the threshold based on the traffic information calculated by the traffic information calculating unit 11.

The IPsec packet receiving unit 13 receives IPsec packets from the opposing apparatus. The IPsec authentication key determining unit 14 determines the normality of an IPsec authentication key. The IPsec HSN comparing unit 15 compares the sequence number of a received IPsec packet with the threshold set by the receivable HSN setting unit 12, to thereby determine whether the sequence number of the received IPsec packet exceeds the threshold.

The HSN inquiry transmitting unit 16 (an inquiry transmitting unit) transmits an inquiry packet for requesting a check on the highest sequence number to the opposing apparatus in the case when the sequence number of the received IPsec packet is more than the threshold. The inquiry packet includes information allowing a request for a check on the highest sequence number in IPsec packets having been transmitted by the opposing apparatus. The IP packet transmitting unit (up-link) 17 transmits an IP packet to the opposing apparatus (in the uplink direction).

The HSN response receiving unit 18 receives a response packet from the opposing apparatus in reply to the inquiry packet. The response packet includes information allowing the identification of the highest sequence number in the IPsec packets having been transmitted by the opposing apparatus. The IPsec packet SN comparing unit 19 compares the sequence number of the IPsec packet in the process of confirmation (i.e., a suspected packet) with the highest sequence number received from the opposing apparatus, to thereby determine whether the sequence number of the suspected packet is more than the highest sequence number.

The IPsec HSN updating unit 20 updates the highest sequence number of the anti-replay window. When the IPsec HSN comparing unit 15 has determined that the sequence number of the received IPsec packet is not more than the threshold, the IPsec HSN updating unit 20 updates the highest sequence number of the anti-replay window. In addition, when the IPsec packet SN comparing unit 19 has determined that the sequence number of the suspected packet is not more than the highest sequence number received from the opposing apparatus, the IPsec HSN updating unit 20 updates the highest sequence number of the anti-replay window. The IPsec HSN updating unit 20 sets the sequence number of the received IPsec packet as a new highest sequence number of the anti-replay window.

For anti-replay protection, the IPsec packet SN duplication determining unit 21 determines whether a received packet has a duplicate sequence number. The determination for anti-replay protection is made with reference to a bitmap of the anti-replay window. For anti-replay protection, the IPsec packet SN location determining unit 22 determines the location of the sequence number of the received IPsec packet in relation to the anti-replay window. Specifically, the IPsec packet SN location determining unit 22 determines whether the sequence number of the received IPsec packet is an old sequence number outside the anti-replay window.

The IPsec packet drop processing unit 23 drops a malformed packet according to a determination result for anti-replay protection. The IPsec packet drop processing unit 23 drops the malformed packet in each of the following cases: when the IPsec packet SN comparing unit 19 has determined that the sequence number of the suspected packet is more than the highest sequence number; when the IPsec packet SN duplication determining unit 21 has determined that there is a duplicated sequence number; and when the IPsec packet SN location determining unit 22 has determined that the sequence number of the received IPsec packet is an old sequence number outside the anti-replay window.

Note that an integrated assembly of the HSN response receiving unit 18, the IPsec packet SN comparing unit 19, and the IPsec packet drop processing unit 23 implements functions equivalent to the anti-replay control unit 3 of the first embodiment.

The IP packet decrypting unit 24 decrypts an accepted IPsec packet. The IP packet transmitting unit (down-link) 25 transmits an IP packet to the communication device 41 (in the downlink direction).

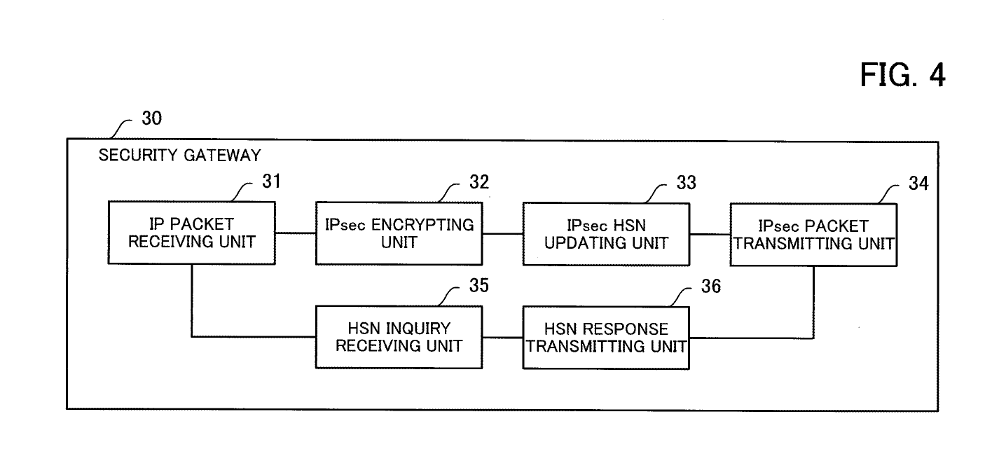

Functions of the security gateway 30 are described next with reference to FIG. 4. FIG. 4 illustrates an example of a functional configuration of the security gateway according to the second embodiment. The security gateway 30 includes an IP packet receiving unit 31, an IPsec encrypting unit 32, an IPsec HSN updating unit 33, and an IPsec packet transmitting unit 34. The security gateway 30 also includes a HSN inquiry receiving unit 35 and a HSN response transmitting unit 36.

The IP packet receiving unit 31 receives IP packets from the core network 40. The IPsec encrypting unit 32 encrypts the IP packets received by the IP packet receiving unit 31 to generate IPsec packets. The IPsec HSN updating unit 33 updates its own managing highest sequence number with the highest one of sequence numbers attached to the generated IPsec packets. The IPsec packet transmitting unit 34 transmits the IPsec packets to the radio base station apparatus 10.

The HSN inquiry receiving unit 35 receives an inquiry packet from the radio base station apparatus 10. The HSN response transmitting unit 36 (a response transmitting unit) transmits, to the radio base station apparatus 10, a response packet with the highest sequence number updated by the IPsec HSN updating unit 33.

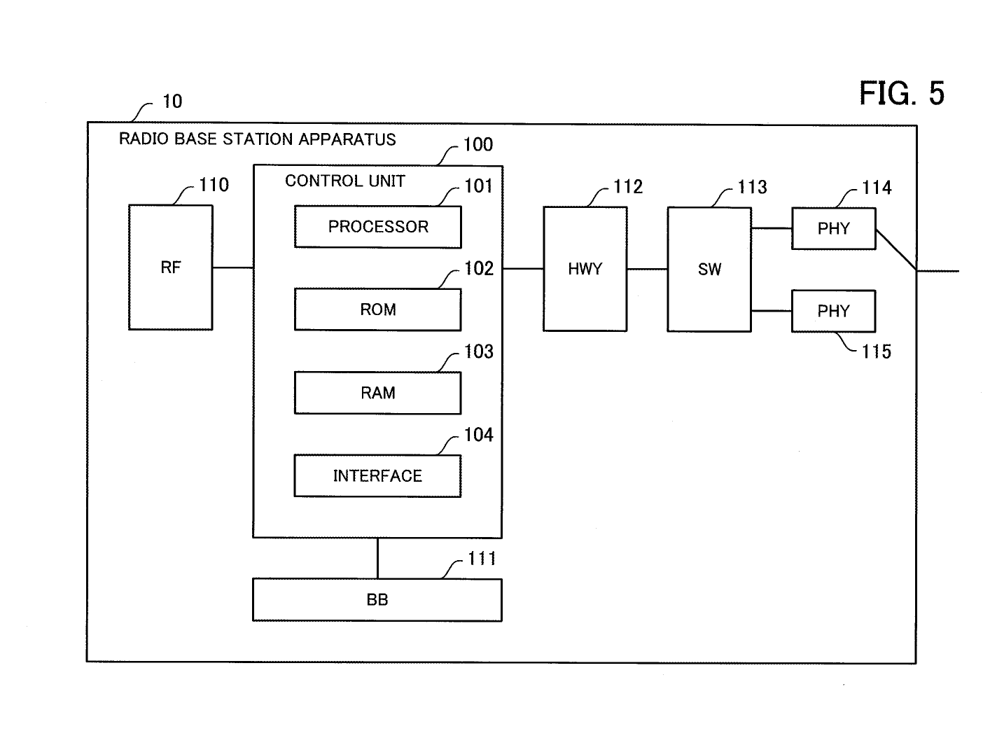

Next described is a hardware configuration of the radio base station apparatus 10 with reference to FIG. 5. FIG. 5 illustrates an example of a hardware configuration of the radio base station apparatus according to the second embodiment. The radio base station apparatus 10 includes a radio frequency unit (RF) 110, a control unit 100, a baseband unit (BB) 111, a highway (HWY) 112, a switch (SW) 113, and physical layers (PHY) 114 and 115.

The radio frequency unit 110 converts (for example, up-converts) a baseband signal into a radio frequency signal, which is then output to an antenna (not illustrated). The radio frequency unit 110 also converts (for example, down-converts) a radio frequency signal received by the antenna to output a baseband signal. The baseband unit 111 converts a data signal into a baseband signal, which is then output to the radio frequency unit 110. The baseband unit 111 also extracts data from the baseband signal output from the radio frequency unit 110. The highway 112 functions as an IPsec endpoint, and exchanges messages using IKE. The switch 113 is a Layer 2 or Layer 3 switch controlling its communication destination. The PHYs 114 and 115 provide physical communication connection functions.

The control unit 100 exercises overall control of the radio base station apparatus 10. Then, overall control of the control unit 100 is exercised by a processor 101. To the processor 101, read only memory (ROM) 102, random access memory (RAM) 103, an interface 104, and a plurality of peripherals are connected via a bus (not illustrated). The processor 101 may be a multi-processor. The processor 101 is, for example, a central processing unit (CPU), a micro processing unit (MPU), a digital signal processor (DSP), an application specific integrated circuit (ASIC), a programmable logic device (PLD) or a combination of two or more of these.

The ROM 102 holds memory contents when the power is disconnected from the control unit 100. The ROM 102 is, for example, a semiconductor storage device such as an electrically erasable programmable read-only memory (EEPROM) or a flash memory, or a hard disk drive (HDD). The ROM 102 is used as a secondary storage device of the control unit 100. The ROM 102 stores therein an operating system (OS) program, firmware, application programs, and various types of data.

The RAM 103 is used as a main storage device of the control unit 100. The RAM 103 temporarily stores at least part of the OS program, firmware, and application programs to be executed by the processor 101. The RAM 103 also stores therein various types of data to be used by the processor 101 for its processing. The RAM 103 may include cache memory separately from the memory for storing the various types of data. The peripherals connected to the bus include an interface 104. The interface 104 is connected to an input/output device and supports input and output communications.

The hardware configuration described above achieves the processing functions of the radio base station apparatus 10 according to the second embodiment. Note that the packet transmission apparatus 1 of the first embodiment may be built with the same hardware configuration as the radio base station apparatus 10 of FIG. 5.

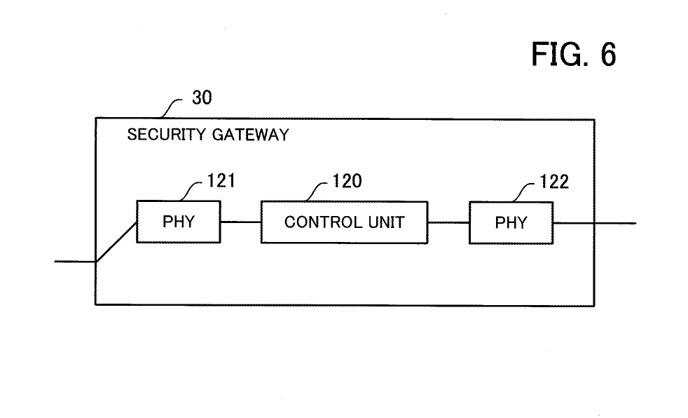

Next described is a hardware configuration of the security gateway 30 with reference to FIG. 6. FIG. 6 illustrates an example of a hardware configuration of the security gateway according to the second embodiment. The security gateway 30 includes a control unit 120 and PHYs 121 and 122. The PHYs 121 and 122 provide physical communication connection functions. The control unit 120 exercises overall control of the security gateway 30. The control unit 120 has the same configuration as the control unit 100 of the radio base station apparatus 10. Note that the opposing apparatus 4 of the first embodiment may be built with the same hardware configuration as the security gateway 30 of FIG. 6.

Each of the radio base station apparatus 10, the security gateway 30, the packet transmission apparatus 1, and the opposing apparatus 4 achieves its processing functions of the first or second embodiment, for example, by implementing a program stored in a computer-readable storage medium. The program describing processing contents to be implemented by each of the radio base station apparatus 10, the security gateway 30, the packet transmission apparatus 1, and the opposing apparatus 4 may be stored in various types of storage media. For example, the program may be stored in the ROM 102. The processor 101 loads at least part of the program stored in the ROM 102 into the RAM 103 and then runs the program. In addition, the program may be stored in portable storage media, such as an optical disk, a memory device, and a memory card (not illustrated). Examples of the optical disk include a digital versatile disc (DVD), a DVD-RAM, a compact disc read only memory (CD-ROM), a CD recordable (CD-R), and a CD-rewritable (CD-RW). The memory device is a storage medium having a function for communicating with the interface 104 or a device connection interface (not illustrated). For example, the memory device is able to write and read data to and from the memory card using a memory reader/writer. The memory card is a card type storage medium. The program stored in such a portable storage medium becomes executable after being installed in the ROM 102, for example, under the control of the processor 101. Alternatively, the processor 101 may run the program by directly reading it from the portable storage medium.

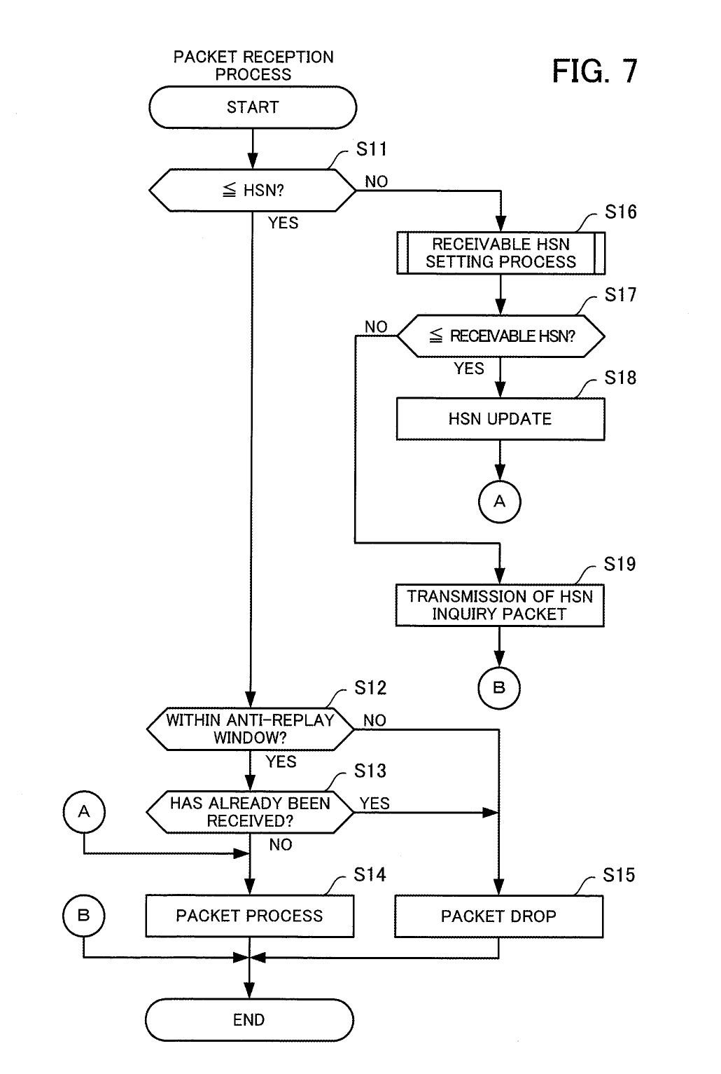

Next described is a packet reception process executed by the radio base station apparatus 10 with reference to FIG. 7. FIG. 7 is a flowchart of the packet reception process according to the second embodiment. The packet reception process is executed by the control unit 100 when the radio base station apparatus 10 receives an IPsec packet.

[Step S11] The control unit 100 compares the sequence number of the received IPsec packet and the highest sequence number. If the sequence number of the received IPsec packet is not more than the highest sequence number, the control unit 100 proceeds to step S12. On the other hand, if the sequence number of the received IPsec packet is more than the highest sequence number, the control unit 100 proceeds to step S16. The highest sequence number is the largest sequence number in validly received IPsec packets, and is located at the head (i.e., corresponds to the newest packet) of the anti-replay window.

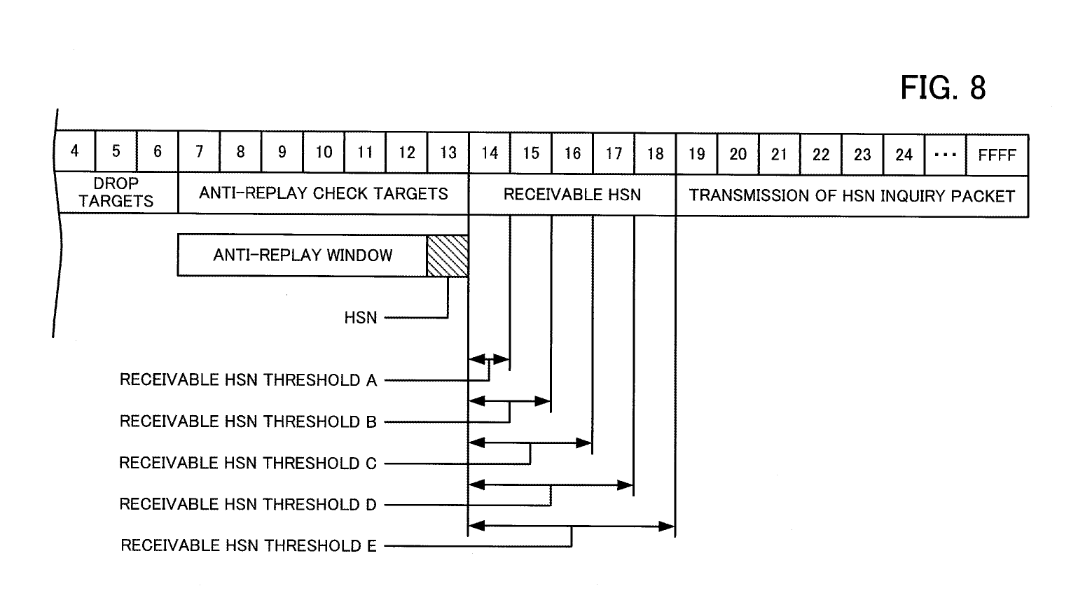

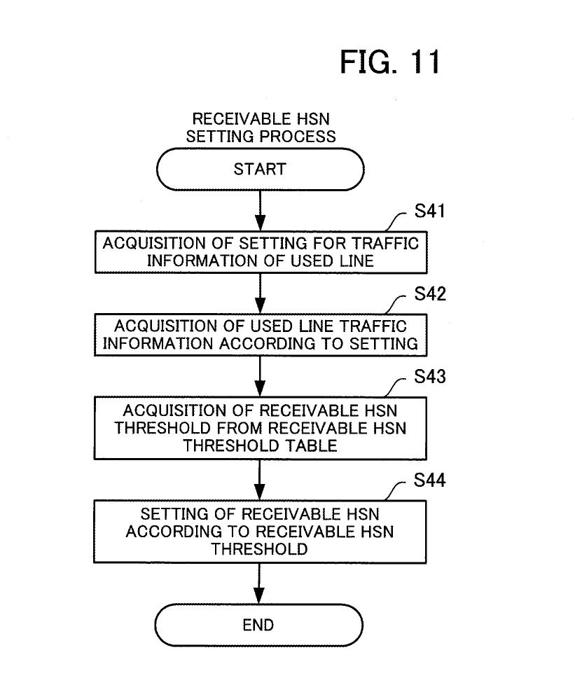

An example of the anti-replay window is depicted in FIG. 8. FIG. 8 illustrates an example of the anti-replay window according to the second embodiment. As for the exemplified anti-replay window, the highest sequence number is “13” and the window size is seven packets. Note that the execution of step S11 by the control unit 100 implements a function of the IPsec HSN comparing unit 15.

[Step S12] The control unit 100 determines the location of the sequence number of the received IPsec packet in relation to the anti-replay window for anti-replay protection. Specifically, the control unit 100 determines whether the sequence number of the received IPsec packet falls within the anti-replay window. If the sequence number of the received IPsec packet falls within the anti-replay window, the control unit 100 proceeds to step S13. On the other hand, if the sequence number of the received IPsec packet falls outside the anti-replay window, that is, if the sequence number of the received IPsec packet is an old sequence number outside the anti-replay window, the control unit 100 proceeds to step S15. For example, in FIG. 8, sequence numbers not exceeding “6” are old sequence numbers outside the anti-replay window and therefore drop targets. Note that the execution of step S12 by the control unit 100 implements a function of the IPsec packet SN location determining unit 22.

[Step S13] The control unit 100 determines reception of a duplicate sequence number for anti-replay protection. With reference to the bitmap of the anti-replay window, the control unit 100 determines whether the sequence number of the received IPsec packet has already been received. If the sequence number of the received IPsec packet has not already been received, the control unit 100 proceeds to step S14. On the other hand, if the sequence number of the received IPsec packet has already been received, the control unit 100 proceeds to step S15. For example, in FIG. 8, sequence numbers from “7” on up to “13” are targets of the duplicate reception determination (anti-replay check targets). Note that the execution of step S13 by the control unit 100 implements a function of the IPsec packet SN duplication determining unit 21.

[Step S14] The control unit 100 performs a packet process, accepting the received IPsec packet as valid (authentic). The packet process is, for example, decryption of the IPsec packet. In this case, the execution of step S14 by the control unit 100 implements a function of the IP packet decrypting unit 24. After executing the packet process, the control unit 100 ends the packet reception process.

[Step S15] The control unit 100 drops the received IPsec packet, regarding it as invalid (malformed), and then ends the packet reception process. Note that the execution of step S15 by the control unit 100 implements a function of the IPsec packet drop processing unit 23.

[Step S16] The control unit 100 executes a receivable HSN setting process. The receivable HSN setting process is to set the largest sequence number, the IPsec packet of which is to be accepted as valid without the need for an inquiry to the security gateway 30. For example, assuming that a receivable HSN threshold E illustrated in FIG. 8 has been set, if the sequence number of the received IPsec packet is any of sequence numbers “14” to “18”, the received IPsec packet is accepted as valid without an inquiry to the security gateway 30. The details of the receivable HSN setting process are described later with reference to FIG. 11. Note that the execution of step S16 by the control unit 100 implements a function of the receivable HSN setting unit 12.

[Step S17] The control unit 100 compares the sequence number of the received IPsec packet and the receivable highest sequence number. If the sequence number of the received IPsec packet is not more than the receivable highest sequence number, the control unit 100 proceeds to step S18. On the other hand, if the sequence number of the received IPsec packet is more than the receivable highest sequence number, the control unit 100 proceeds to step S19. Note that the execution of step S17 by the control unit 100 implements a function of the IPsec HSN comparing unit 15.

[Step S18] The control unit 100 updates the highest sequence number of the anti-replay window with the sequence number of the received IPsec packet, and then proceeds to step S14. Note that the execution of step S18 by the control unit 100 implements a function of the IPsec HSN updating unit 20.

[Step S19] The control unit 100 transmits an inquiry packet for the highest sequence number to the security gateway 30, and then ends the packet reception process. For example, assuming that the receivable HSN threshold E of FIG. 8 has been set, if the sequence number of the received IPsec packet is “19” or above, the received IPsec packet is not accepted as valid without an inquiry to the security gateway 30. At this point, the IPsec packet whose sequence number is now a target of the highest sequence number inquiry is put on hold, remaining as a suspected packet, without undergoing either the packet process in step S14 or the packet drop in step S15. Note that the execution of step S19 by the control unit 100 implements a function of the HSN inquiry transmitting unit 16.

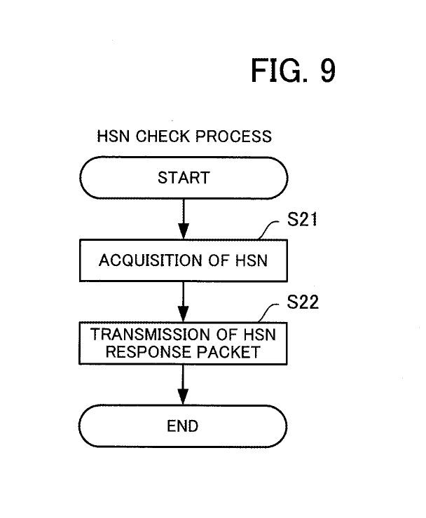

Next described is a HSN check process executed by the security gateway 30 with reference to FIG. 9. FIG. 9 is a flowchart of the HSN check process according to the second embodiment. The HSN check process is executed by the security gateway 30 upon reception of the inquiry packet transmitted by the radio base station apparatus 10 in step S19 of the packet reception process.

[Step S21] According to the received inquiry packet, the control unit 120 acquires the highest sequence number in IPsec packets having been transmitted to the radio base station apparatus 10. Note that the highest sequence number is updated and managed by the IPsec HSN updating unit 33. Note that the execution of step S21 by the control unit 120 implements a function of the HSN inquiry receiving unit 35.

[Step S22] The control unit 120 generates a response packet with the acquired highest sequence number attached thereto, and transmits the response packet to the radio base station apparatus 10 having transmitted the inquiry packet. Subsequently, the control unit 120 ends the HSN check process. Note that the execution of step S22 by the control unit 120 implements a function of the HSN response transmitting unit 36.

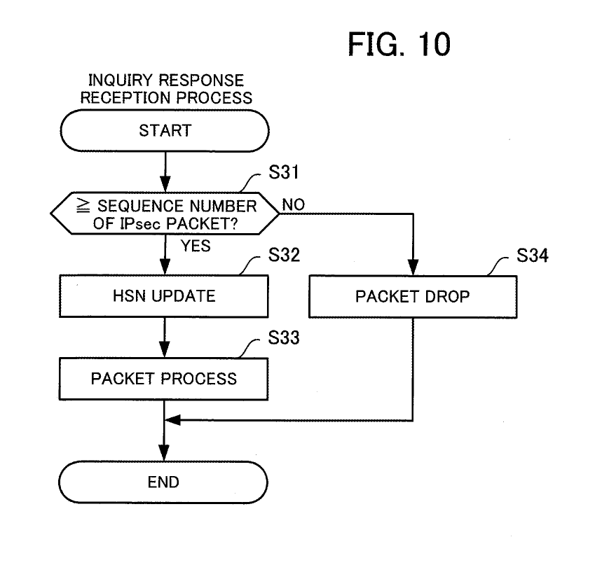

Next described is an inquiry response reception process executed by the radio base station apparatus 10 with reference to FIG. 10. FIG. 10 is a flowchart of the inquiry response reception process according to the second embodiment. The inquiry response reception process is to determine the handling of the suspected packet put on hold in step S19. The inquiry response reception process is executed by the control unit 100 when the radio base station apparatus 10 receives the response packet.

[Step S31] The control unit 100 determines whether the highest sequence number received from the security gateway 30 is more than or equal to the sequence number of the IPsec packet in the process of confirmation (the suspected packet). If the highest sequence number is more than or equal to the sequence number of the suspected packet, the control unit 100 proceeds to step S32. On the other hand, if the highest sequence number is not more than or equal to the sequence number of the suspected packet, the control unit 100 proceeds to step S34. Note that the execution of step S31 by the control unit 100 implements a function of the IPsec packet SN comparing unit 19.

[Step S32] The control unit 100 updates the highest sequence number of the anti-replay window. That is, the control unit 100 determines that the suspected packet is a valid packet because the sequence number of the suspected packet is less than or equal to the highest sequence number received from the security gateway 30. Note that the execution of step S32 by the control unit 100 implements a function of the IPsec HSN updating unit 20.

[Step S33] The control unit 100 performs a packet process, accepting the received IPsec packet as valid (authentic). The packet process is, for example, decryption of the IPsec packet. In this case, the execution of step S33 by the control unit 100 implements a function of the IP packet decrypting unit 24. After executing the packet process, the control unit 100 ends the inquiry response reception process.

[Step S34] The control unit 100 drops the received IPsec packet, regarding it as invalid (malformed), and then ends the inquiry response reception process. Note that the execution of step S34 by the control unit 100 implements a function of the IPsec packet drop processing unit 23.

Thus, the radio base station apparatus 10 makes an inquiry to the security gateway 30 about the suspected packet for updating the highest sequence number, to thereby detect an attack forging the highest sequence number to counteract such threats. Herewith, the radio base station apparatus 10 is able to prevent the occurrence of communication failures due to the attack forging the highest sequence number and avoid adverse effects on the continuation of services of a packet transmission apparatus (the radio base station apparatus is an example of such) and a packet transmission system. Therefore, the radio base station apparatus 10 is able to provide a reliable communication network while preventing service interruptions.

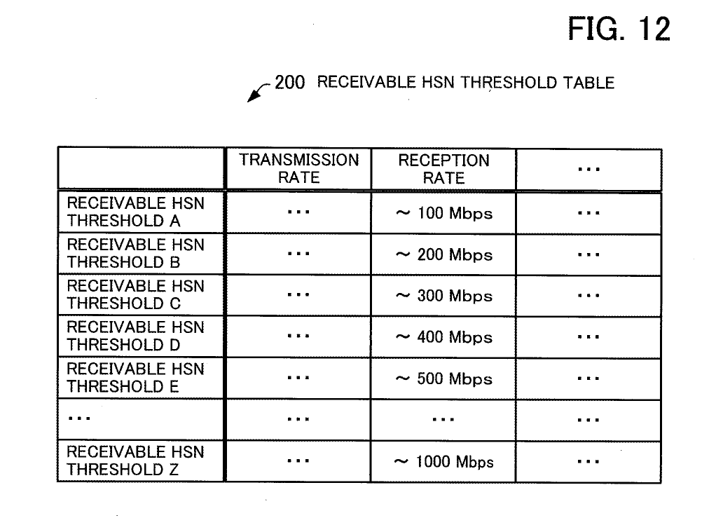

Next described is a receivable HSN setting process executed by the radio base station apparatus 10 with reference to FIG. 11. FIG. 11 is a flowchart of the receivable HSN setting process according to the second embodiment. The receivable HSN setting process is to set a receivable highest sequence number based on traffic information of a communication line used. The receivable HSN setting process is executed by the radio base station apparatus 10 in step S16 of the packet reception process.

[Step S41] The control unit 100 acquires a setting for traffic information of the used line. The used line traffic information is a traffic information item set for use amongst multiple types of traffic information items of the communication line used. The traffic information items are, for example, a transmission rate (Mbps) and a reception rate (Mbps), and one of such items is set in advance.

[Step S42] The control unit 100 acquires used line traffic information according to the setting acquired in step S41. The used line traffic information is calculated by the traffic information calculating unit 11. Then, the control unit 100 acquires the used line traffic information calculated by the traffic information calculating unit 11. For example, in the case where the setting for the used line traffic information is “reception rate (Mbps)”, the control unit 100 acquires the reception rate of the used line.

[Step S43] The control unit 100 acquires a receivable HSN threshold from a receivable HSN threshold table. The receivable HSN threshold table is described with reference to FIG. 12. FIG. 12 illustrates an example of the receivable HSN threshold table according to the second embodiment. In a receivable HSN threshold table 200, the first column (left-hand side) includes receivable HSN thresholds of different magnitudes arranged in ascending order. Each of the second and subsequent columns is dedicated to a traffic information item, each entry of which corresponds to a different one of the receivable HSN thresholds. In the receivable HSN threshold column, “Receivable HSN Threshold A”, “Receivable HSN Threshold B”, “Receivable HSN Threshold C”, . . . , and “Receivable HSN Threshold Z” are listed from the top. The traffic information items listed are “transmission rate”, “reception rate”, and the like.

Each traffic information item has thresholds individually corresponding one of the receivable HSN thresholds. For example, the traffic information item “reception rate” has a threshold of “100 Mbps” corresponding to “Receivable HSN Threshold A”, which is followed by subsequent thresholds of “200 Mbps”, “300 Mbps”, . . . , and “1000 Mbps”. In the case where the setting of the used line traffic information is “reception rate (Mbps)”, if an acquired reception rate is “250 Mbps”, the control unit 100 acquires “Receivable HSN Threshold C” from the receivable threshold table 200 as a receivable HSN threshold.

Now let us return to the description of the receivable HSN setting process.

[Step S44] The control unit 100 sets a receivable highest sequence number according to the receivable HSN threshold. For example, in the case where the control unit 100 acquires “Receivable HSN Threshold C” as a receivable HSN threshold, a value obtained by adding “Receivable HSN Threshold C” to the highest sequence number is the receivable highest sequence number. According to the example of FIG. 8, because “Receivable HSN Threshold C” is “3” and the highest sequence number is “13”, the receivable highest sequence number becomes “16 (=13+3)”.

After setting the receivable highest sequence number, the control unit 100 ends the receivable HSN setting process. Note that the execution of step S44 by the control unit 100 implements a function of the receivable HSN setting unit 12.

Thus, in the case of receiving a suspected packet with a sequence number exceeding the highest sequence number, the radio base station apparatus 10 eliminates the need for an inquiry to the security gateway 30 when the magnitude of the exceedance is within an appropriate range according to the traffic of the communication line. This reduces the load of the radio base station apparatus 10 for checking suspected packets while avoiding adverse effects on the continuation of services of a packet transmission apparatus (the radio base station apparatus 10 is an example of such) and a packet transmission system. As a result, the radio base station apparatus 10 is able to provide a reliable communication network while preventing service interruptions.

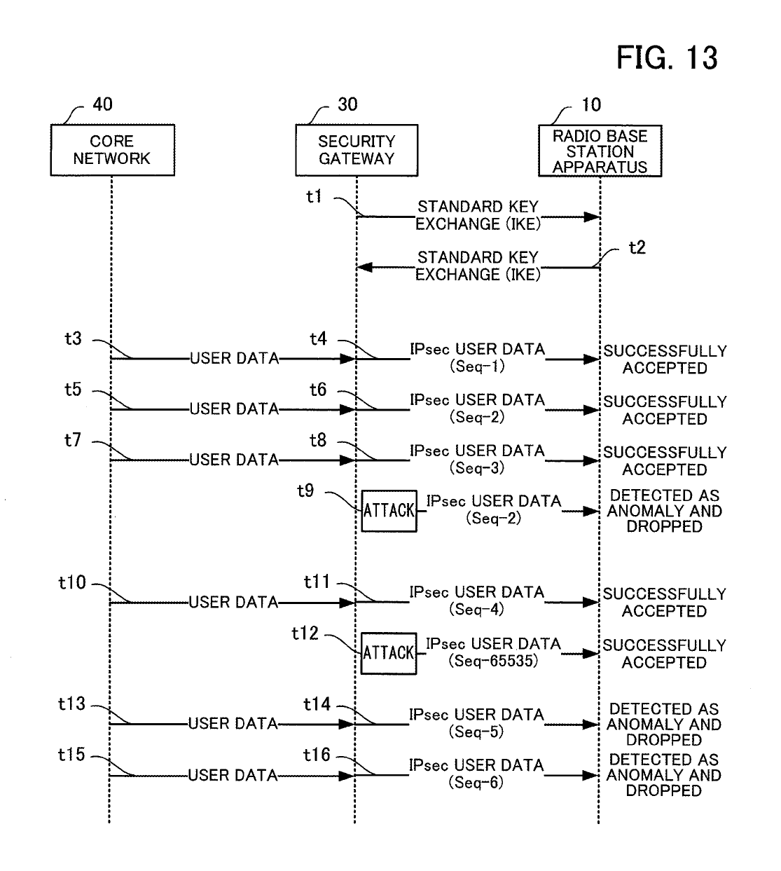

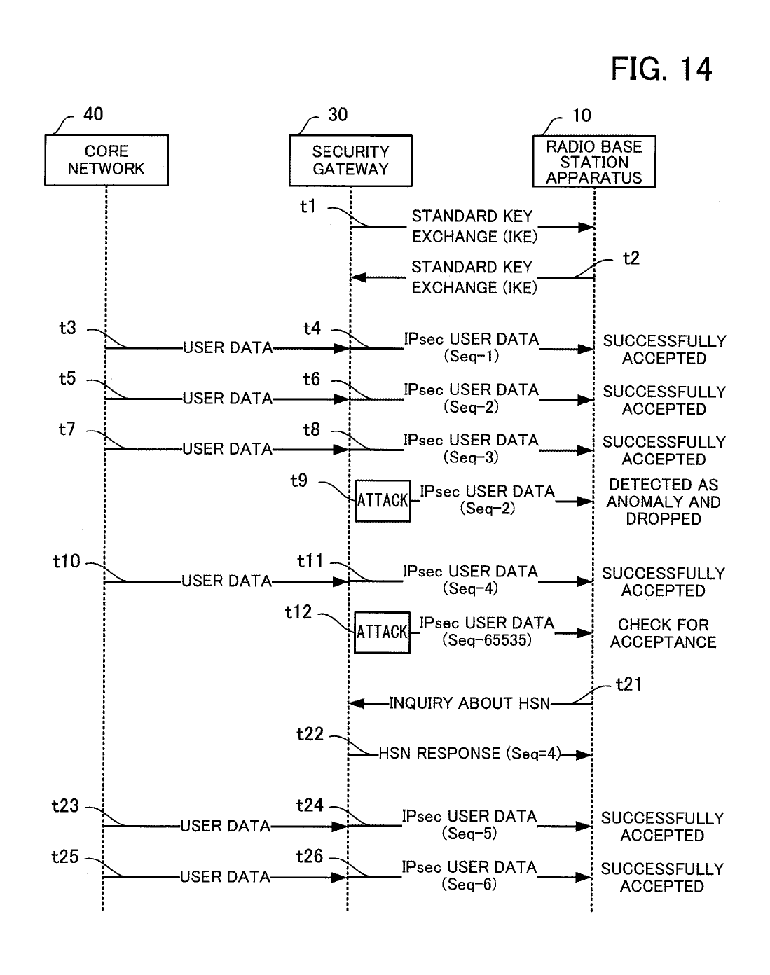

Next described are an example of an attack forging the highest sequence number and an example of defense against the attack forging the highest sequence number, with reference to FIGS. 13 and 14. First, the example of an attack forging the highest sequence number is described using FIG. 13. FIG. 13 is a sequence diagram illustrating an example of an attack forging the highest sequence number. The security gateway 30 and the radio base station apparatus 10 carry out standard key exchange using IKE (times t1 and t2). Herewith, the communication section 42 using IPsec is established between the security gateway 30 and the radio base station apparatus 10.

The core network 40 transmits user data to the security gateway 30 (time t3). The security gateway 30 generates an IPsec packet (IPsec user data) from the user data received from the core network 40 and then transmits the IPsec packet to the radio base station apparatus 10 (time t4). Similarly, based on user data transmitted by the core network 40 (times t5 and t7), the security gateway 30 generates IPsec user data and transmits the IPsec user data to the radio base station apparatus 10 (times t6 and t8). The IPsec user data transmitted at time t4 has a sequence number of “1”, the IPsec user data transmitted at time t6 has a sequence number of “2”, and the IPsec user data transmitted at time t8 has a sequence number of “3”.

Assuming here that a replay attack using IPsec user data with the sequence number “2” is made (time t9), the IPsec user data is detected as an anomaly by the anti-replay function and then dropped because the IPsec user data with the sequence number “2” was already received at time t6. Based on user data transmitted by the core network 40 (time t10), the security gateway 30 generates IPsec user data and transmits the IPsec user data to the radio base station apparatus 10 (time t11). The IPsec user data with a sequence number of “4” is normally received because the radio base station apparatus 10 has not previously received the IPsec user data with the sequence number “4”.

Assuming further that a replay attack using IPsec user data with a sequence number of “65535” is made (time t12), the IPsec user data is normally received in the case of conventional technology because the radio base station apparatus 10 has not previously received the IPsec user data with the sequence number “65535”. From then on, based on user data transmitted by the core network 40 (times t13 and t15), the security gateway 30 generates IPsec user data and transmits the IPsec user data to the radio base station apparatus 10 (times t14 and t16). However, since the anti-replay window has shifted largely by the IPsec user data with the sequence number “65535”, the radio base station apparatus 10 drops the IPsec user data with the sequence numbers of “5” and “6”, regarding them as anomalous IPsec user data with old sequence numbers outside the anti-replay window. This is an example of an attack forging the highest sequence number.

Next described is an example of applying the technique according to the second embodiment, that is, an example of defense against the attack forging the highest sequence number, with reference to FIG. 14. FIG. 14 is a sequence diagram illustrating an example of defense against the attack forging the highest sequence number. Because events up to time t11 are the same as those of FIG. 13, a repeated description thereof is omitted, and the following description starts from an event at time t12.

At time t12, the radio base station apparatus 10 receives the IPsec user data with the sequence number “65535”. However, because the sequence number “65535” is more than a receivable highest sequence number, the radio base station apparatus 10 identifies the IPsec user data with the sequence number “65535” as a suspected packet which entails an inquiry to the security gateway 30 before being accepted. Note that, at this point, the highest sequence number is “4” since the radio base station apparatus 10 has received the IPsec user data with sequence numbers up to “4”, and the receivable highest sequence number is a value obtained by adding a receivable HSN threshold to the highest sequence number “4”.

The radio base station apparatus 10 transmits an inquiry packet for requesting a check on the highest sequence number to the security gateway 30 (time t21). Upon reception of the inquiry packet from the radio base station apparatus 10, the security gateway 30 checks its own managing highest sequence number and transmits a response packet indicating the checked highest sequence number to the radio base station apparatus 10 (time t22). The response packet transmitted by the security gateway 30 indicates that the highest sequence number is “4”. Then, the radio base station apparatus 10 compares the sequence number “65535” of the suspected packet with the highest sequence number “4” received from the security gateway 30. Because the sequence number “65535” of the suspected packet is more than the highest sequence number “4” received from the security gateway 30, the radio base station apparatus 10 drops the suspected packet. In this manner, the radio base station apparatus 10 is able to provide protection against an attack forging the highest sequence number.

The radio base station apparatus 10 drops the suspected packet to thereby prevent the anti-replay window from shifting maliciously. From then on, based on user data transmitted by the core network 40 (times t23 and t25), the security gateway 30 generates IPsec user data and transmits the IPsec user data to the radio base station apparatus 10 (times t24 and t26). Even after the attack trying to forge the highest sequence number, the radio base station apparatus 10 is able to successfully accept the IPsec user data with the sequence numbers “5” and “6”.

Thus, even if receiving a suspected packet whose sequence number exceeds the highest sequence number, the radio base station apparatul 10 is able to avoid adverse effects on the continuation of services of a packet transmission apparatus (the radio base station apparatus 10 is an example of such) and a packet transmission system. Therefore, the radio base station apparatus 10 is able to provide a reliable communication network while preventing service interruptions.

The processing functions described in each of the embodiments above may be achieved by a computer. In this case, a program is provided which describes processing contents of the functions to be implemented by each of the packet transmission apparatus 1, the opposing apparatus 4, the radio base station apparatus 10, and the security gateway 30. By executing the program on the computer, the above-described processing functions are achieved on the computer. The program in which the processing contents are described may be recorded on computer-readable storage media. Such computer-readable storage media include a magnetic storage device, an optical disk, a magneto-optical storage medium, and a semiconductor memory. Examples of the magnetic storage device are a HDD, a flexible disk (FD), and a magnetic tape. Examples of the optical disk are a DVD, a DVD-RAM, a CD-ROM, and a CD-RW. An example of the magneto-optical storage medium is a magneto-optical disk (MO).

To distribute the program, for example, portable storage media, such as DVDs and CD-ROMs, on which the program is recorded are sold. In addition, the program may be stored in a memory device of a server computer and then transferred from the server computer to another computer via a network.

A computer for executing the program stores, for example, in its own memory device, the program which is originally recorded on a portable storage medium or transferred from the server computer. Subsequently, the computer reads the program from its own memory device and performs processing according to the program. Note that the computer is able to read the program directly from the portable storage medium and perform processing according to the program. In addition, the computer is able to sequentially perform processing according to a received program each time such a program is transferred from a server computer. In addition, at least part of the above-described processing functions may be achieved by an electronic circuit, such as a DSP, an ASIC, and a PLD.

According to one aspect, it is possible to provide an apparatus and system for packet transmission, which provide a reliable communication network while preventing service interruptions.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A packet transmission apparatus comprising:
an inquiry transmitting unit configured to transmit, upon detecting a suspected packet with a sequence number exceeding a highest sequence number set in an anti-replay window used to detect duplication of a sequence number of a received packet, a highest sequence number inquiry to an opposing apparatus; and
an anti-replay control unit configured to drop the suspected packet when the sequence number of the suspected packet is more than a highest sequence number acquired from a response of the opposing apparatus in reply to the highest sequence number inquiry.

2. The packet transmission apparatus according to claim 1, further comprising a setting unit configured to set, as a receivable highest sequence number, a largest sequence number with which the suspected packet is to be accepted without a need for the transmission of the highest sequence number inquiry,
wherein the inquiry transmitting unit transmits, upon detecting the suspected packet with the sequence number exceeding the receivable highest sequence number, the highest sequence number inquiry to the opposing apparatus.

3. The packet transmission apparatus according to claim 2, further comprising an acquiring unit configured to acquire traffic information of a line used,
wherein the setting unit sets the receivable highest sequence number based on the traffic information.

4. The packet transmission apparatus according to claim 3, wherein the setting unit selects, amongst the receivable highest sequence number being provided in plurality, one of the receivable highest sequence numbers based on the traffic information.

5. The packet transmission apparatus according to claim 1, wherein the highest sequence number acquired from the response of the opposing apparatus is a largest sequence number in packets having been transmitted by the opposing apparatus.

6. The packet transmission apparatus according to claim 1, wherein the received packet is an Internet Protocol Security Protocol (IPsec) packet.

7. A packet transmission system comprising:
a first packet transmission apparatus; and
a second packet transmission apparatus configured to transmit and receive packets to and from the first packet transmission apparatus,
wherein the first packet transmission apparatus includes:
an inquiry transmitting unit configured to transmit, upon detecting a suspected packet with a sequence number exceeding a highest sequence number set in an anti-replay window used to detect duplication of a sequence number of a received packet, a highest sequence number inquiry to the second packet transmission apparatus, and
an anti-replay control unit configured to drop the suspected packet when the sequence number of the suspected packet is more than a highest sequence number acquired from a response of the second packet transmission apparatus in reply to the highest sequence number inquiry, and
the second packet transmission apparatus includes:
a response transmitting unit configured to transmit, upon reception of the highest sequence number inquiry from the first packet transmission apparatus, a highest sequence number in transmitted packets as the response to the first packet transmission apparatus.
